(19) United States
(12) Patent Application Publication
(10) Pub. No.: US 2010/0028755 A1
(43) Pub. Date: Feb. 4, 2010

(54) Fuel Cell Catalyst Layer, Membrane Electrode Assembly Using the Same and Fuel Cell

(75) Inventor: Kohei Shiramizu, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Tokyo (JP)

(21) Appl. No.: 12/185,017

(22) Filed: Aug. 1, 2008

(51) Int. Cl. H01M 4/90

(52) U.S. Cl. 429/40

(57) ABSTRACT

One embodiment of the present invention is a fuel cell catalyst layer including sulfonated amorphous carbons, wherein the sulfonated amorphous carbons have a chemical shifts signal indicating carbons of a condensed aromatic 6-membered ring to which sulfonic groups are attached and are not attached respectively in a spectrum of the ¹³C-NMR, and have a diffraction peak signal corresponding to the carbon's (002) plane whose half-value width (2θ) is 5-30 degrees in a spectrum of powder x-ray diffraction, and show the proton conductivity.

### BACKGROUND OF THE INVENTION

1. Field of the Invention

The present invention relates to a fuel cell/battery catalyst layer containing sulfonated amorphous carbons. This invention also relates to a membrane electrode assembly and a fuel cell/battery which utilize said catalyst layer.

2. Description of the Related Art

In recent years, fuel cells that have high energy efficiencies and cause few environmental burdens are attracting attention. Fuel cells/batteries electrochemically oxidize fuels such as hydrogen or methanol etc. with oxide or air and generate electrical energy by transforming the fuel's chemical energy.

Depending on the kind of electrolyte used, fuel cells are classified into several types such as solid polymer type, phosphoric acid type, molten carbonate type, solid oxide type and alkali type. Among these, the solid polymer fuel cell whose electrolyte is a cation-exchange membrane can reduce its internal resistance by using a thinner electrolyte membrane. Therefore, the solid polymer fuel cell can operate at a high current to make the fuel cell compact and small. This advantage serves to accelerate the development of the solid polymer fuel cell.

The solid polymer fuel cell is generally composed of many stacking unit cells. The unit cell has a sandwich structure in which a membrane electrode assembly is arranged between separators which have flow paths for fuel gases or oxidant gases. The membrane electrode assembly is composed of an anode, a cathode and an electrolyte membrane which is made of a proton conductive polymer and sits between the two electrodes (namely, the anode and the cathode).

One of the key issues for encouraging widespread utilization of the solid polymer fuel cell is the reduced use of a platinum catalyst in the catalyst layer of the membrane electrode assembly. This is because the world's reserves of platinum are limited. It is said that if all of the present automobiles were shifted from gasoline-powered to fuel-cell-driven automobiles, the required platinum would exceed the world's reserves of platinum from the point of view of the required platinum amount per unit area in the present technology. The second reason is cost. It is said that the cost prospect of the membrane electrode assembly is too high to put the fuel cell into practical and widespread use, considering the required platinum amount per unit area in the present technology.

In order to reduce platinum consumption it is essential to use platinum more effectively. FIG. 5 is a partial exemplary diagram showing an example of a conventional catalyst layer. According to the conventional recipe of catalytic varnish, in which only the electrolyte of a proton conductive polymer (13) and the platinum catalyst loading carbons (14) are dissolved in a solvent, the platinum catalyst loading carbons (14) which are mixed in the solvent, clump together in the varnish. Then, even if some platinum catalyst loading carbons (11) can provide electrolyte (13) with protons, other platinum catalyst loading carbons (12) can not. This means protons produced in the platinum catalyst loading carbon (12) are not used effectively due to the absence of the proton conductive polymer electrolyte because the proton conductive polymer electrolyte penetrates poorly in the clump of the catalyst layer. Consequently, it becomes difficult to promote efficient use of platinum and this disadvantage results in insufficient battery performance per unit amount of platinum. Particularly when equipped on a vehicle, the fuel gas diffusion and the battery performance tends to be more insufficient because larger instant currents are required than in the case of cogeneration unit use.

The present invention aims to provide a catalyst layer which has a higher output performance but requires less platinum catalyst. In addition, this invention provides a fuel cell and a membrane electrode assembly thereof using said catalyst layer.

### SUMMARY OF THE INVENTION

As a result of keen investigations, the inventor found that sulfonated amorphous carbons have proton conductivity and can seep into the clump of the platinum catalyst loading carbons because both are made from an identical element (carbon) and easily blend together. And the inventor concluded that the sulfonated amorphous carbons serve to efficiently utilize the platinum catalyst loading carbons which are deep in the clump and make it possible to reduce the amount of the platinum catalyst.

Hence, the present invention provides the following <1> to <10>.

<1> One embodiment of the present invention is a fuel cell catalyst layer comprising sulfonated amorphous carbons.

FIG. 1 is a partial exemplary diagram showing an example of the catalyst layer of this invention. The sulfonated amorphous carbons (2) can seep into the clump of the platinum catalyst (4) loading carbons (1) because both are made from an identical element (carbon) and easily blend together. Therefore, the catalyst layer including the amorphous carbons (2) can efficiently utilizes platinum catalysts (4) loading carbons (1) and makes it possible to increase the output performance and reduce the amount of the platinum catalyst. The number (3) in FIG. 1 designates the electrolyte.

<2> Another embodiment of the present invention is a fuel cell catalyst layer, wherein the proton conductivity of the sulfonated amorphous carbons is 0.01 S/cm or more. This proton conductivity is a value measured by an alternate current impedance method at a temperature of 80 degrees Celsius and humidity of 100%.

The amorphous carbons with a proton conductivity of 0.01 S/cm or more can conduct protons generated inside the carbons effectively. A proton conductivity of less than 0.01 S/cm is too low to reduce the amount of the platinum catalyst.

<3> Another embodiment of the present invention is a fuel cell catalyst layer, wherein the sulfonated amorphous carbons have chemical shifts indicating carbons of a condensed aromatic 6-membered ring to which sulfonic groups are attached and are not attached respectively in the spectrum of the ¹³C-NMR, and have a diffraction peak corresponding to the carbon's (002) plane whose half-value width (2θ) is 5-30 degrees in the spectrum of powder x-ray diffraction, and show proton conductivity.

The sulfonated amorphous carbons are stacked in layers with platinum catalyst loading carbons by the π-π interactions of the condensed aromatic 6-membered ring. Consequently, carbons which contain platinum catalysts are prevented from clumping together and the protons inside the catalysts are conducted effectively.

<4> Another embodiment of the present invention is a fuel cell catalyst layer, wherein the only diffraction peak signal corresponding to the carbon's (002) plane is detected in the spectrum of powder x-ray diffraction of the sulfonated amorphous carbons.

If the sulfonated amorphous carbons have such a pure grade, the protons are conducted still more efficiently inside the catalysts.

<5> Another embodiment of the present invention is a fuel cell catalyst layer, wherein the density of sulfonic acids in the sulfonated amorphous carbons is 2-12 mmol/g.

If the density of sulfonic acids in the sulfonated amorphous carbons is less than 2 mmol/g, the proton conductivity becomes too low. If the density of sulfonic acids in the sulfonated amorphous carbons is more than 12 mmol/g, the synthetic yield of the sulfonated amorphous carbons becomes too low.

<6> Another embodiment of the present invention is a fuel cell catalyst layer, wherein the weight ratio of the sulfonated amorphous carbons is 0.1-50%.

If the weight ratio of the sulfonated amorphous carbons within the entire dry solid content of the catalyst layer is less than 0.1%, it is inevitable that the platinum catalysts clump together and the amount of the platinum catalysts cannot be reduced. On the contrary, if the weight ratio of the sulfonated amorphous carbons within the entire dry solid content of the catalyst layer is more than 50%, the non-crystalline carbons with sulfonic groups are too many to form a three-phase interfacial boundary and the power generating efficiency becomes worse.

<7> Another embodiment of the present invention is a fuel cell catalyst layer, wherein the weight ratio of the sulfonated amorphous carbons is 0.5-10%.

When the weight ratio of the non-crystalline carbons is particularly in the 0.5-10% range the platinum can be used effectively and the power generating efficiency becomes high.

<8> Another embodiment of the present invention is a fuel cell catalyst layer, wherein the amount of platinum is 0.3 mg/cm² or less per electrode and the output power is 0.7 W/cm² or more under 80 degrees Celsius and 1 A current.

Such a catalyst layer remarkably reduces platinum consumption compared to the conventional technology which consumes platinum at about 1 mg/cm². This will also contribute to environment conservation.

<9> Another embodiment of the present invention is a membrane electrode assembly which utilizes the fuel cell catalyst layer.

This kind of membrane electrode assembly uses a platinum catalyst effectively and has good performance.

<10> Another embodiment of the present invention is a fuel cell which utilizes the fuel cell catalyst layer.

This kind of fuel cell uses a platinum catalyst effectively and has good performance.

### BRIEF DESCRIPTION OF THE DRAWINGS

FIG. 1 is a partial schematic diagram of one example of the catalyst layer of this invention.

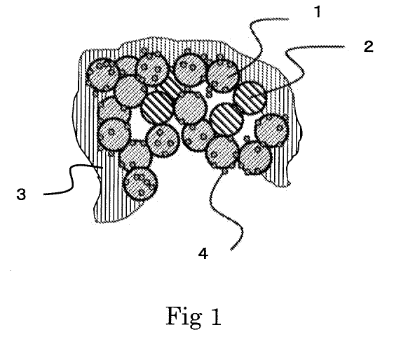

FIG. 2 shows a manufacturing process of sulfonated amorphous carbons from a raw organic compound.

FIG. 3 is the ¹³C NMR (Nuclear Magnetic Resonance) spectrum of the sulfonated amorphous carbons, which are obtained in the reference example 3.

FIG. 4 is the powder X-ray diffraction pattern of the sulfonated amorphous carbons, which are obtained in the reference example 3.

FIG. 5 is a partial schematic diagram of one example of a conventional catalyst layer.

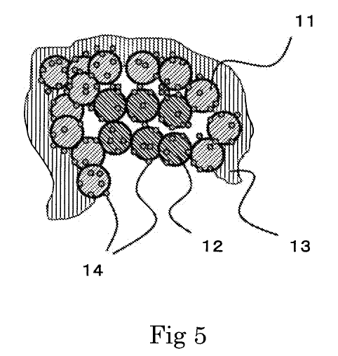

### DESCRIPTION OF REFERENCE NUMERALS AND SIGNS

1: Platinum catalyst loading carbon
2: Sulfonated amorphous carbons
3: Electrolyte
4: Platinum catalyst
11: Platinum catalyst loading carbons which provide an electrolyte with protons
12: Platinum catalyst loading carbons which do not provide an electrolyte with protons
13: Proton conductive polymer electrolyte
14: Platinum catalyst

### DETAILED DESCRIPTION OF THE INVENTION

The present invention is described in detail below.

The composition of matter of the present invention is especially characterized in the further involvement of the sulfonated amorphous carbons in the catalyst layers, which consist of proton conductive polymer electrolyte and platinum loading catalyst carbons in the conventional technology.

Any carbons which have sulfonic groups and show amorphous carbon properties can be used as the sulfonated amorphous carbons of this invention. An amorphous carbon hereby means a material made from carbon which has no specific crystalline structure such as diamond or graphite, and more specifically, has only a broad peak or no distinct peak in its powder X-ray diffraction spectrum.

Preferable examples for the sulfonated amorphous carbons are: (1) sulfonated amorphous carbons which have the following properties (A), (B) and (C); (2) sulfonated amorphous carbons which have the following properties (A), (B), (C), (D) and (E); (3) sulfonated amorphous carbons which have the following properties (C) and (F), where:

(A) The chemical shifts signal indicating the carbons of a condensed aromatic 6-membered ring to which sulfonic groups are attached and are not attached respectively is detected in the spectrum of the ¹³C-NMR (nuclear magnetic resonance).
(B) The diffraction peak signal corresponding to the carbon's (002) plane whose half-value width (2θ) is 5-30 degrees is detected in the spectrum of powder x-ray diffraction.
(C) Proton conductivity is observed.
(D) The density of sulfonic acids is 0.5-14 mmol/g.
(E) The ratio of the number of carbon atoms to which sulfonic groups are attached is up to 3-20% out of all the carbon atoms.
(F) The content of sulfur is 0.3-15 atm %.

With regard to the property (B), although peaks other than carbon (002) may be detected, it is more preferable that the carbon's (002) plane is the only detectable peak.

With regard to the property (C), although there is no limitation to proton conductivity, 0.01 S/cm or more is the preferable range. The proton conductivity of the amorphous carbons equal to or more than 0.01 S/cm enables effective conduction of protons generated in the inner carbons. A proton conductivity less than 0.01 S/cm is so low that it is impossible to reduce platinum catalysts. This proton conductivity means the value measured by an alternating current impedance method under the condition of a temperature at 80 degrees Celsius and humidity of 100%.

With regard to the property (D), the density of sulfonic acids has to be 0.5-14 mmol/g. It is, however, more preferable that it is 2-12 mmol/g. If the density of sulfonic acids is too low, proton conduction will be insufficient and platinum consumption cannot be reduced. On the contrary, if the density of sulfonic acids is too high, the synthetic yield of the sulfonated amorphous carbons falls.

With regard to the property (F), the content of sulfur has to be 0.3-15 atm %. It is, however, more preferable that it is 3-10 atm %.

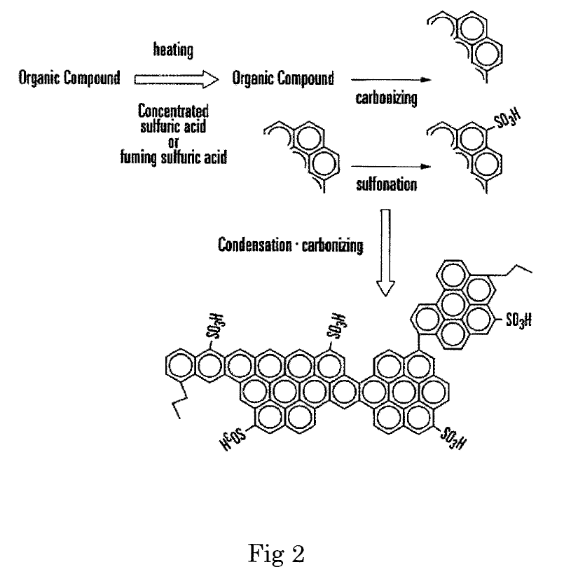

The sulfonated amorphous carbons are produced, for example, by heating organic compounds in concentrated sulfuric acid or fuming sulfuric acid. The outline of this production method is illustrated in FIG. 2. Heating treatment of organic compounds in concentrated sulfuric acid or fuming sulfuric acid promotes carbonization, sulfonation and condensation between carbon rings. As a result, the sulfonated amorphous carbons are produced as illustrated in FIG. 2.

It is necessary to perform a heating treatment of organic compounds in concentrated sulfuric acid or fuming sulfuric acid under the flow current of dry air or inactive gas such as nitrogen or argon to produce amorphous carbons with a high sulfonic acid density. A more preferable treatment is blowing dry air or inactive gas such as nitrogen, argon etc. into the concentrated sulfuric acid or fuming sulfuric acid which includes organic compounds while heating. The reaction of aromatic compounds with concentrated sulfuric acid, which produces aromatic sulfonic acid and water, is an equilibrium reaction. Thus, as water increases in the reaction system, the amount of sulfonic acid incorporated into the amorphous carbons decreases dramatically because the reverse reaction is accelerated. Amorphous carbons with high sulfonic acid density can be produced when the reaction is performed under the flow current of inactive gases or dry air, which removes water actively from the reaction system.

Sulfonation reaction as well as condensation, cyclization and partial carbonization of organic compounds takes place in the heating treatment. Therefore, the reaction temperature has no specific limitation but needs to be sufficiently high so that these reactions proceed. It may be around 100-350° C. for industrial production, or more preferably 150-250° C. The reaction temperature lower than 100° C. causes insufficient condensation and carbonization of organic compounds and may lead to incomplete carbon formation. In the case where the reaction temperature is higher than 350° C., a thermal decomposition of sulfonic groups can be induced.

The heating duration is determined appropriately in accordance with the kind of organic compounds, reaction and temperature etc. It is ordinarily likely to be 5-50 hours and is preferred to be 10-20 hours.

Although the concentrated sulfuric acid or the fuming sulfuric acid usage has no limitation, it is ordinarily likely to be 2.6-50.0 mol and is preferred to be 6.0-36.0 mol in proportion to 1 mol of the organic compounds.

Aromatic hydrocarbons can be used as the organic compounds. Other organic compounds for example natural compounds such as glucose, succulose and cellulose, or synthetic polymers such as polyethylene and polyacrylamides are also available. The aromatic hydrocarbons include both polycyclic aromatic hydrocarbons and monocyclic aromatic hydrocarbons. Therefore benzene, naphthalene, anthracene, perylene, and coronene etc. can be used and especially naphthalene is preferable among them. One kind of these organic compounds alone or plural kinds of these organic compounds together can be used in this invention. In addition, it is not necessary to use refined organic compounds. For example, heavy oils which contain hydrocarbons, pitch oils, tar oils or asphalts can be used.

In the case where synthetic polymers or natural compounds such as glucose or cellulose are used as raw materials, it is preferred that they are partially carbonized by heating in an inactive gas flow ahead of the heating treatment in concentrated sulfuric acid and/or fuming sulfuric acid. The heating temperature of these is ordinary 100-350° C. and the heating duration is ordinary 1-20 hours. It is desirable that the diffraction peak signal which corresponds to the carbon's (002) plane and whose half-value width (2θ) is 30 degrees is detected in the powder x-ray diffraction spectrum of the heated raw material after the partial carbonization treatment.

In the case where the raw materials are the aromatic hydrocarbons or heavy oils which contain aromatic hydrocarbons, pitch oils, tar oils, or asphalts etc., it is preferred that the product material is heated under a vacuum after the heating treatment in concentrated sulfuric acid or fuming sulfuric acid. This will help to remove any surplus sulfuric acid and also encourage carbonization and solidification of the product material, which increases the yield. With regard to evacuation, it is preferred to use a vacuum pump whose exhaust velocity is 10 L/min. or more and ultimate vacuum is 13.3 kPa or lower. The preferable temperature is 140-300 degrees Celsius, especially 200-280 degrees Celsius. The vacuum duration under this temperature is ordinary 2-20 hours.

In addition, chemically treated, for example, fluorinated materials made from sulfonated amorphous carbons can also be used preferably in this invention. In particular, fluorination is useful because it makes the acidity of sulfonic groups stronger.

Polymer electrolytes which conduct protons can be used preferably as the proton conductive polymer electrolyte in this invention. Among them, proton conductive polymer electrolyte in which sulfonic groups are incorporated especially shows superior proton conductivity. Sulfonated products which are made from resins exemplified below can be used as these polymer electrolytes. Either the single product alone or a mixture of any combination of the products can be used. Derivatives or copolymers of these resins can also be used. These resins are, for example, epoxy resin, urea resin, silicone resin, propylene resin, phenol resin, xylene resin, melamine resin, polyester resin, alkyd resin, vinylidene resin, furan resin, urethane resin, polyphenylene ether resin, polycarbonate resin, acrylate resin, amide resin, imide resin, vinyl resin, carboxylic resin, fluorine resin, nylon resin, styrene resin and other engineering plastics. But this is not all. In addition to this, not only the organic polymers cited above but also organic-inorganic hybrid polymers, silicate resins, liquid glasses and various kinds of inorganic polymers can also be used. Among them, sulfonated fluorine resins particularly show good performance. As sulfonated fluorine resins, fluorine series proton conductive polymer electrolytes which are named “Nafion” (a registered trademark) by Dupont (E. I. du Pont de Nemours and Company), “Flemion” (a registered trademark) by ASAHI GLASS Co., LTD. or etc. are commercially supplied. Furthermore, sulfonated partial-fluorine resins, which are partially fluorine-substituted, also show good performances. When made into a film, the proton conductive electrolyte described above can be used as a proton conductive electrolyte membrane.

The above stated engineering plastics have no limitation as long as they have thermostability of 100 degrees Celsius or more, strength of 49.0 MPa or more and flexural modulus of 2.4 GPa or more. This includes polyamide, polybuthylene terephthalate, polycarbonate, polyacetal, modified polyphenylene oxide, modified polyphenylene ether, polyphenylene sulfide, polyether ether ketone and polyether sulfone, polysulphone, polyamide imide, polyether imide, polyimide, polyarylate, polyaryl ether nitrile etc. Among them, modified polyphenylene oxide, modified polyphenylene ether, polyphenylene sulfide, polyether ether ketone, polyether sulfone, polysulphone, polyamide imide, polyether imide, polyimide, polyarylate, polyaryl ether nitrile are especially preferred because of their high level of stability. Sulfonated products of these materials also show good output characteristics.

A catalyst made from platinum or platinum-alloy is preferred for use in the platinum catalyst loading carbon incorporated in a catalyst layer of this invention. In addition, a platinum-alloy serves to increase the stability and/or activity of the platinum catalyst loading carbons as an electrode catalyst in some cases.

It is preferred that this platinum-alloy be made from platinum and metal(s) which is/are selected from the following: platinum-group metal other than platinum (i.e. ruthenium, rhodium, palladium, osmium, iridium), gold, silver, chromium, iron, titanium, manganese, cobalt, nickel, molybdenum, tungsten, aluminum, silicon, zinc, and tin. This platinum-alloy may include an intermetallic compound of platinum. Especially a platinum-alloy with ruthenium or cobalt is preferable when the supplied anode gas contains carbon monoxide since the catalyst activity becomes stable.

In addition, catalysts other than platinum such as tungsten carbide can also be used in this invention.

As an example of a manufacturing method of the membrane electrode assembly using sulfonated amorphous carbons, which is a content of this invention, is exemplified hereafter. A manufacturing method of the membrane electrode assembly using sulfonated amorphous carbons of this invention is illustrated below. First, sulfonated amorphous carbons, a proton conductive polymer electrolyte and platinum catalyst loading carbons are mixed in a solvent to prepare a catalytic varnish. Next, the varnish is coated on conductive porous bodies such as carbon fibers or carbon papers and dried to make electrodes which contain a catalyst layer. These electrodes are bonded by thermal compression to an electrolyte film such as a Nafion, a sulfonated engineering plastic etc. by means of a pressing machine to create a membrane electrode assembly. At this time, an adhesive agent obtained by dissolving a proton conductive polymer electrolyte in a thinner might be used in order to improve thermal compression bonding. Assembling with separators and other supplementary equipment (gas supply units, cooling apparatus etc.), a single sheet or stacked sheets of the membrane electrode assembly is/are made into a fuel cell. Since the thermal compression bonding described above is only an example, the membrane electrode assembly is also obtained by replacing the thermal compression bonding of the previous described process with coating the catalytic varnish on carbon fibers or carbon papers etc. by a spraying method.

Carbon fibers such as carbon paper, carbon cloth and carbon felt and porous bodies of other conductive materials such as a metal are examples of the conductive porous bodies of this invention and they can all be used either with a fuel gas diffusion layer or with an air diffusion layer. Considering corrosion resistance etc., carbon fibers are more preferable than metals in many cases. Moreover, carbon fibers which have a filler layer made from carbon black and fluorine series binder may be used in order to make and keep good contact with the catalyst layer. As such materials, LT-1200 made by E-TEC Corporation, for example, is commercially available and can be applied to this invention preferably.

This invention provides a catalyst layer which includes sulfonated amorphous carbons, has high proton conductivity, high heat resistance and high output characteristics and low costs. This invention also provides a membrane electrode assembly and a fuel cell using this catalyst layer. The hydrogen adsorption area, which expands as the platinum catalysts are used efficiently, becomes larger than ever. Hence even in the case of less platinum, the output characteristics of the membrane electrode assembly of this invention remarkably exceed those of a conventional method. Moreover, since an addition of the sulfonated amorphous carbons prevents the catalytic varnish from clumping together, solvent content in the catalytic varnish can be reduced, which serves to decrease the burden of the environment.

### EXAMPLES

This invention is clarified with specific examples hereafter but the specific examples do not limit this invention.

### [Preparation of Varnish]

Sulfonated amorphous carbons, proton conductive polymer electrolyte and platinum catalyst loading carbons were combined in a solvent to make mixtures which have the weight percent ratio as illustrated in Table 1 in order to prepare catalytic varnishes. The total matter shown in Table 1 corresponded to sulfonated amorphous carbons, proton conductive polymer electrolyte and platinum catalyst loading carbons. This total matter was mixed and kneaded in a ball mill. Varnishes which had 10% or 15% of the total matter were prepared. The viscosity was measured by VISCOMATE VM-1A-MH made by Yamaichi Electronics Co., Ltd.

The contents of the catalytic varnishes are illustrated in Table 1.

TABLE 1

| | a | b | c | d |
|---|---|---|---|---|
| Compound | 3 | 3 | | |
| Benzenesulfonic | | | | 3 |
| acid | | | | |
| Nafion | 32 | 32 | 35 | 32 |
| Platinum catalyst | 65 | 65 | 65 | 65 |
| attached carbons | | | | |
| Total matter % | 10 | 15 | 10 | 10 |
| Viscosity mPa * S | 60 | 400 | 400 | 380 |

Sulfonated amorphous carbons: Compound (below)
Proton conductive polymer electrolyte: Nafion

Total matter %=(weight of compound or benzenesulfonic acid+weight of proton conductive polymer electrolyte+weight of platinum catalyst attached carbons+weight of solvent)×100

### [Compound]

Naphthalene was added to concentrated sulfuric acid (96%) and heated at 250° C. for 15 hours. After residual sulfuric acid was removed by distillation under reduced pressure, black powder was obtained. This black powder was rinsed with 300 ml of fresh distilled water repeatedly until the amount of sulfuric acid fell below a measurable limit of an elemental analysis. Then sulfonated amorphous carbons were obtained and the density of sulfonic acids was 4.5 mmol/g. After being sifted, the resulting carbon compounds showed proton conductivity of 0.1 S/cm.

### [Formation of a Catalyst Layer and Production of a Membrane Electrode Assembly]

Each catalytic varnish described above was coated on carbon fibers so that the platinum catalyst amount became 0.3 mg/cm² respectively and was dried to make electrodes which contained catalyst layers. These electrodes were bonded to electrolyte films of Nafion 112 or by thermal compression using a pressing machine. Consequently, membrane electrode assemblies, on which anode and cathode electrodes were formed, were obtained.

Table 2 shows examples of the membrane electrode assembly and their platinum catalyst amounts.

TABLE 2

| | Example 1 | Example 2 | Comparative example 1 |
|---|---|---|---|
| Varnish | a | b | c |
| Electrolyte | Nafion 112 | Nafion 112 | Nafion 112 |
| film | | | |
| Platinum | 0.3 | 0.3 | 0.3 |
| catalyst | | | |
| amount mg/cm³ | | | |

### [Evaluation]

### Hydrogen Adsorption Area:

Each membrane electrode assembly was to be attached by separators. Then, its cyclic voltammetry was measured with fuel cell test equipment (GFT-SG1 made by TOYO Corporation) under the condition of 40° C. and RH 100%. The adsorption area is obtained from the cyclic voltammetry waveform of hydrogen desorption. The larger the adsorption area is, the more efficiently and the better platinum is used.

### Output Characteristics:

Each membrane electrode assembly was to be attached by separator. Then, its current-voltage characteristics were measured by fuel cell test equipment (GFT-SG1 made by TOYO Corporation) under the condition of 80 degrees Celsius and RH 100%. The output mW/cm² when the current density was 1 A/cm² was obtained, flowing oxygen to one electrode and hydrogen to the other to generate electric power.

The results are shown in Table 3.

TABLE 3

| | Example 1 | Example 2 | Comparative example 1 |
|---|---|---|---|
| Adhesiveness | ∘ | ∘ | ∘ |
| Hydrogen | 280 | 290 | 220 |
| adsorption area | | | |
| cm²/mg | | | |
| Output | 700 | 720 | 530 |
| characteristics | | | |
| mW/cm² | | | |

A catalyst layer which contains 3% of sulfonated amorphous carbons had a large hydrogen adsorption area of 280 cm²/mg and high output characteristics of 700 mW/cm² (example 1). In contrast, a catalyst layer which did not contain 3% of sulfonated amorphous carbons had a small hydrogen adsorption area of 220 cm²/mg and low output characteristics of 530 mW/cm² (comparative example 1). Moreover, an addition of 3% of sulfonated amorphous carbons turned out to remarkably reduce the viscosity of varnish ‘a’ from 400 mPaS to 60 mPaS to keep platinum catalyst loading carbons from clumping together. Furthermore, the viscosity reduction capability of this type turned out to be very weak at 380 mPaS in benzenesulfonic acid so that the aggregation of platinum catalyst loading carbons was not prevented. (Table 1)

These facts mentioned above imply that platinum catalyst loading carbons and sulfonated amorphous carbons fit in each other to reduce platinum catalyst loading carbons not in use and consequently platinum catalyst loading carbons were allowed to receive more hydrogen, which means the hydrogen adsorption area was broadened. Also, since sulfonated amorphous carbons had a larger aromatic rings area and had stronger π-π stack bonding to carbons than benzenesulfonic acid, it appears that their viscosity reduction brought about a more dramatic effect than that of benzenesulfonic acid. The π-π stack bonding is a specific intermolecular force in aromatics. Moreover, in example 2, in which varnish ‘b’ containing less solvent was used in order to adjust the viscosity to 400 mPaS, showed a large hydrogen adsorption area of 290 cm²/mg and high level of output characteristics of 720 mW/cm². Thus this invention allows less solvent usage which serves to reduce a burden on the environment. This reduction increases up to 5%, which might appear minor but in fact achieves a major effect when in the process of mass production.

As described above, catalyst layers containing sulfonated amorphous carbons had a large hydrogen adsorption area and high level of output characteristics.

Sulfonated amorphous carbons are synthesized by simple and easy reactions such as carbonization and sulfonation. And they have high density such as 4.5 mmol/g of sulfonate acid and show high proton conductivity. Moreover, it is unnecessary to synthesize their raw material because it is wasted as large scale industrial waste as sulfate pitch. Thus, this invention serves to remarkably reduce a burden on the environment by recycling industrial waste.

Sulfonated amorphous carbons are hereafter described in detail in the reference examples and the reference measurement examples.

First, measurement equipment and measurement methods applied to these reference examples are explained.

¹³C MAS (Magic angle spinning) NMR (Nuclear magnetic resonance) spectrum measurement: ASX200 (made by Bruker. Measuring frequency: 50.3 MHz) was used.

X-ray analysis system: Geigerflex RAD-B, CuKα (made by Rigaku Corporation) was used.

Elemental analyzer which utilizes flash combustion: CHSN-932 (made by LECO (in U.S.)) was used.

Measurement of proton conductivity: Measurements were performed by an AC (alternating current) impedance method. A film-like sample with 10 mm diameter under the condition of RH (relative humidity) 100% was pinched by a platinum electrode and was encapsulated in a hermetically-closed cell. Impedance absolute value and phase angle of the cell was measured at frequency 5-13 MHz, applied voltage 12 mV and temperature 20° C., 50° C. and 100° C. respectively by means of an impedance analyzer (HYP4192A). With the obtained data, the complex impedance was measured at an oscillating voltage of 12 mV using a computer and the proton conductivity was calculated.

Measurement of sulfonate acid density: 1 g out of the product was dispersed in 100 ml of distilled water to be titrated with 0.1 M aqueous sodium hydroxide. The point of neutralization was determined by a pH meter.

### Reference Example 1

### Production of Sulfonated Amorphous Carbons from Naphthalene

20 g of naphthalene was added to 300 ml of concentrated sulfuric acid (96%) and heated at 250° C. for 15 hours. After surplus concentrated sulfuric acid was removed by vacuum distillation at 250° C., black powder was obtained. Then this black powder was washed by 300 ml of distilled water repeatedly until no sulfuric acid was detected by elemental analysis from the residual distilled water. Consequently, sulfonated amorphous carbons were obtained.

By pressing this powder of sulfonated amorphous carbons, a disc which was 0.7 mm thick and 10 mm in diameter was produced. After a platinum layer was made by vapor deposition on one side of the disc, its proton conductivity was measured by the AC impedance method described above. The proton conductivity of the sulfonated amorphous carbons at 80 degrees Celsius and RH 100% was confirmed to be 1.1×10⁻¹ S/cm. This indicated the fact that the sulfonated amorphous carbons had proton conductivity comparable to Nafion.

### Reference Example 2

### Production of Sulfonated Amorphous Carbons from Heavy Fuel Oil

10 g of heavy oil was added to 300 ml of concentrated sulfuric acid (96%) and heated at 250° C. for 15 hours. After surplus concentrated sulfuric acid was removed by vacuum distillation at 250° C., black powder was obtained. Then this black powder was washed by 300 ml of distilled water repeatedly until no sulfuric acid was detected by elemental analysis from the residual distilled water. Consequently, sulfonated amorphous carbons were obtained.

By pressing this powder of sulfonated amorphous carbons, a disc which was 0.7 mm thick and 10 mm in diameter was produced. After a platinum layer was made by vapor deposition on one side of the disc, its proton conductivity was measured by the AC impedance method described above. The proton conductivity of the sulfonated amorphous carbons at 80 degrees Celsius and RH 100% was confirmed to be 1.0×10⁻¹ S/cm. This indicated the fact that the sulfonated amorphous carbons had proton conductivity comparable to Nafion.

### Reference Measurement Example 1

### X-Ray Structural Analysis

The structure of the sulfonated amorphous carbons, which were produced in the reference examples 1 and 2, was analyzed by the X-ray analysis system described above. As a result, any sulfonated amorphous carbons, which were produced in the reference examples 1 or 2, did not show any crystal structures in their diffraction patterns and therefore turned out to be amorphous.

### Reference Measurement Example 2

### Measurement of the Sulfur Content

The sulfonated amorphous carbons, which were produced in the reference examples 1 and 2, was burned in an oxygen stream to measure sulfur content by means of the elemental analyzer described above. As a result, sulfur content of the non-crystalline carbons which were produced in the reference examples 1 and 2 were 7.1 atm % and 3.5 atm % respectively. Hence, it was confirmed that many sulfonic groups were incorporated in the amorphous carbons of the reference examples 1 and 2.

### Reference Measurement Examples 3

### Thermal Stability Evaluation

The decomposition temperature of the sulfonated amorphous carbons, which were produced in the reference examples 1 and 2, was measured by a thermal desorption method (multitask TPD of BEL Japan Inc.) and a thermogravimetric method (DTG-60/60H of Shimadzu Corporation). As a result, the decomposition temperatures of the sulfonated amorphous carbons were 250° C. respectively and it was confirmed that they were highly stable when heated.

### Reference Example 3

### Production of Sulfonated Amorphous Carbons from Naphthalene

### An Alternative Method

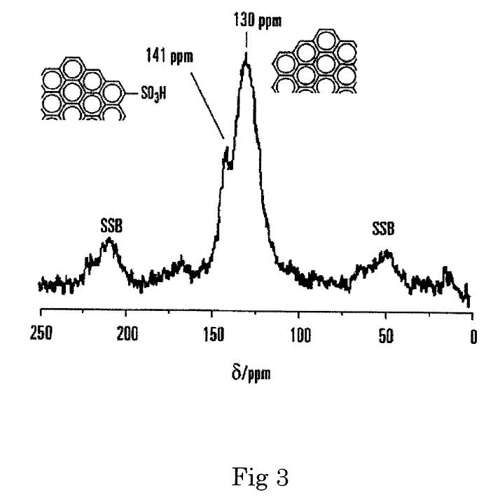

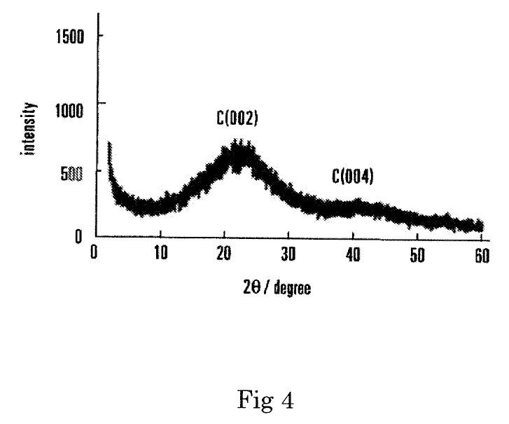

20 g of naphthalene was added to 300 ml of concentrated sulfuric acid (96%) and heated at 250° C. for 15 hours to obtain a black liquid. The liquid was heated at 250° C. for 5 hours being evacuated by a high-vacuum rotary pump whose exhaust velocity was 50 L/min. and ultimate vacuum was 1.33 Pa so that the excess concentrated sulfuric acid was removed and carbonization was promoted to obtain a black powder. After heated at 180 degrees Celsius for 12 hours in an inactive gas stream, this powder was washed with 300 mL of distilled water repeatedly until no sulfuric acid was detected by elemental analysis of the elemental analyzer which utilizes the flash combustion described above. Consequently, sulfonated amorphous carbons were obtained. The ¹³C-NMR spectrum of the obtained non-crystalline carbons is shown in FIG. 3. This ¹³C-NMR spectrum is measured according to a measuring method of ¹³C MAS NMR spectrum which was described above. As is seen in FIG. 3, a chemical shift characteristic of 6-membered carbon ring of condensed aromatic compounds appeared around 130 ppm as well as another chemical shift of sulfonated 6-membered carbon ring of condensed aromatic compounds appearing around 140 ppm. The peak indicated as SSB in FIG. 3 corresponded to a spinning side band which was observed commonly in ¹³C MAS NMR spectrum and did not correspond to any specific carbons. FIG. 4 showed a powder x-ray diffraction pattern measured by means of the X-ray analysis system. As illustrated in FIG. 4, the diffraction peaks corresponding to the (002) plane and the (004) plane of carbon were observed. The half value width (2θ) of the diffraction peak of the (002) plane was 11°. At this time, the density of sulfonic acids of the sulfonated amorphous carbons was 4.9 mmol/g.

After discs of 0.7 mm thick and 10 mm in diameter were made by press forming of the sulfonated amorphous carbons and platinum was deposited on one side of each disc, the proton conductivity was measured by the AC impedance method described above. As a result, the conductivity was 1.1×10⁻¹, which indicated that the sulfonated amorphous carbons had conductivity comparable to that of Nafion.

(The disclosure of Japanese Patent Application No. JP2006-026848, filed on Feb. 3, 2006, is incorporated herein by reference in its entirety.)

What is claimed is:

1. A fuel cell catalyst layer comprising:
sulfonated amorphous carbons.

2. The fuel cell catalyst layer according to claim 1, wherein
a proton conductivity of said sulfonated amorphous carbons measured by an alternate current impedance method at a temperature of 80 degrees Celsius and humidity of 100% is 0.01 S/cm or more.

3. The fuel cell catalyst layer according to claim 1, wherein
said sulfonated amorphous carbons have a chemical shift signal indicating carbons of a condensed aromatic 6-membered ring to which sulfonic groups are attached and are not attached respectively in a spectrum of the ¹³C-NMR, and wherein
the sulfonated amorphous carbons have at least a diffraction peak signal corresponding to the carbon's (002) plane whose half-value width (2θ) is 5-30 degree in a spectrum of powder x-ray diffraction, and wherein
the sulfonated amorphous carbons show a proton conductivity.

4. The fuel cell catalyst layer according to claim 1, wherein
only a diffraction peak signal corresponding to a carbon's (002) plane is detected in a spectrum of powder x-ray diffraction of said sulfonated amorphous carbons.

5. The fuel cell catalyst layer according to claim 1, wherein
a density of sulfonic acids in said sulfonated amorphous carbons is 2-12 mmol/g.

6. The fuel cell catalyst layer according to claim 1, wherein
a weight ratio of said sulfonated amorphous carbons is 0.1-50%.

7. The fuel cell catalyst layer according to claim 1, wherein
a weight ratio of said sulfonated amorphous carbons is 0.5-10%.

8. The fuel cell catalyst layer according to claim 1, wherein
an amount of platinum is 0.3 mg/cm² or less per electrode, and an output power is 0.7 W/cm² or more under 80 degrees Celsius and 1 A current.

9. The fuel cell catalyst layer according to claim 1, wherein
said fuel cell catalyst layer includes a proton conductive polymer electrolyte and platinum catalyst loading carbons.

10. A membrane electrode assembly further comprising
a fuel cell catalyst layer according to claim 1.

11. A fuel cell further comprising
a membrane electrode assembly according to claim 10.
